(19) United States
(12) Patent Application Publication
(10) Pub. No.: US 2012/0063134 A1
(43) Pub. Date: Mar. 15, 2012

(54) LAMP

(75) Inventor: Yen-Chou Hsu, Tao-Yuan City (TW)

(73) Assignee: LEDSTORE INTERNATIONAL CORPORATION, Tao-Yuan City (TW)

(21) Appl. No.: 13/044,915

(22) Filed: Mar. 10, 2011

(30) Foreign Application Priority Data
Sep. 10, 2010 (TW) 099217602

(51) Int. Cl. F21V 1/14; F21V 5/04

(52) U.S. Cl. 362/244

(57) ABSTRACT

A lamp includes a frame; a light emitting mechanism coupled to the frame, the light emitting mechanism comprising a carrier, a plurality of dents disposed on the carrier, light-emitting diodes disposed in the dents, respectively, and series-connected to each other, and a power supply unit connecting with the light-emitting diodes; a lampshade coupled to the frame and configured to hermetically seal the light emitting mechanism; and a plurality of lenses coupled to the lampshade, or coupled to the dents and configured to hermetically seal the light-emitting diodes, respectively. The light-emitting diodes generate light directed to a required position by the lenses due to the directivity of the light-emitting diodes and focused by the lenses, such that the lamp is advantageously characterized by a large illumination angle and capable of saving power.

### CROSS-REFERENCE TO RELATED APPLICATION

This non-provisional application claims priority under 35 U.S.C. §119(a) on Patent Application No(s).099217602 filed in Taiwan, R.O.C. on Sep. 10, 2010, the entire contents of which are hereby incorporated by reference.

### FIELD OF THE INVENTION

The present invention relates to lamps, and more particularly, to a lamp comprising light-emitting diodes for generating light focused by lenses and directed to a required position by the lenses due to the directivity of the light-emitting diodes, such that the lamp is advantageously characterized by a large illumination angle and capable of saving power.

### BACKGROUND OF THE INVENTION

A conventional lamp comprises: a substrate; a plurality of reflective panels disposed on the substrate and oriented obliquely; at least four positioning regions defined within each of the reflective panels to partition the corresponding one thereof; fluorescent tubes positioned within the positioning regions, respectively; and a starter, a transformer, and a wire connected to the fluorescent tubes. In so doing, the required electric power is retrieved by the wire and supplied, by means of the transformer and the start, to the fluorescent tubes for generating light. Once the light is generated by the fluorescent tubes, the light which is emitted bilaterally from each of the fluorescent tubes can reflect off the reflective panels and thereby increase the luminance of the lamp.

Although the conventional lamp comprises the reflective panels for reflecting the light which is emitted bilaterally from each of the fluorescent tubes so as to increase the luminance thereof, the conventional lamp has its own drawbacks. With the reflective panels being oblique and a gap being present between the substrate and the fluorescent tubes, not only does the obliqueness of the reflective panels result in an insufficient path of reflection and preclude the uniform reflection of the light emitted from the fluorescent tubes, but the gap causes extinction to a portion of the light emitted from the fluorescent tubes and thereby compromises the aforesaid reflection and the luminance of the fluorescent tubes. In addition, the conventional lamp not only glares but is bound to bring about a waste of electric power for being equipped with the at least four fluorescent tubes.

Accordingly, it is imperative to invent a lamp which is advantageously characterized by a large illumination angle and capable of saving power.

### SUMMARY OF THE INVENTION

In view of the shortcomings of the conventional lamp, the inventor of the present invention conducted extensive researches and experiments according to the inventor's years of experience in the related industry, and finally developed a lamp characterized by a large illumination angle and capable of saving power as disclosed in the present invention.

It is a primary objective of the present invention to provide a lamp comprising light-emitting diodes for generating light focused by lenses and directed to a required position by the lenses due to the directivity of the light-emitting diodes, such that the lamp is advantageously characterized by a large illumination angle and capable of saving power.

In order to achieve the above and other objectives, the present invention provides a lamp. The lamp comprises: a frame; a light emitting mechanism coupled to the frame, the light emitting mechanism comprising a carrier, a plurality of dents disposed on the carrier, light-emitting diodes disposed in the dents, respectively, and series-connected to each other, and a power supply unit connecting with the light-emitting diodes; a lampshade coupled to the frame and configured to hermetically seal the light emitting mechanism; and a plurality of lenses coupled to the lampshade, or coupled to the dents and configured to hermetically seal the light-emitting diodes, respectively.

In an embodiment of the present invention, the power supply unit comprises a transformer and a plug connected to the transformer.

In an embodiment of the present invention, the lenses are convex lenses or concave lenses.

In an embodiment of the present invention, the lampshade is made of a light-penetrable material.

Accordingly, the present invention provides a lamp comprising light-emitting diodes for generating light directed to a required position by lenses due to the directivity of the light-emitting diodes and focused by the lenses, such that the lamp is advantageously characterized by a large illumination angle and capable of saving power.

### BRIEF DESCRIPTION OF THE DRAWINGS

To enable persons skilled in the art to fully understand the objectives, features, and advantages of the present invention, the present invention is hereunder illustrated with specific embodiments in conjunction with the accompanying drawings, in which:

FIG. 1 is a perspective view of a lamp according to the present invention;

FIG. 2 is an exploded view of the lamp according to the present invention; and

FIG. 3 is a cross-sectional view of the lamp taken along line A-A of FIG. 1 according to the present invention.

### DETAILED DESCRIPTION OF THE PREFERRED EMBODIMENTS

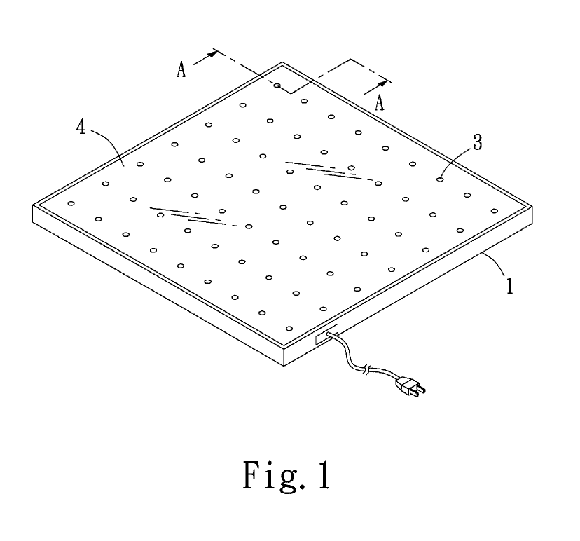

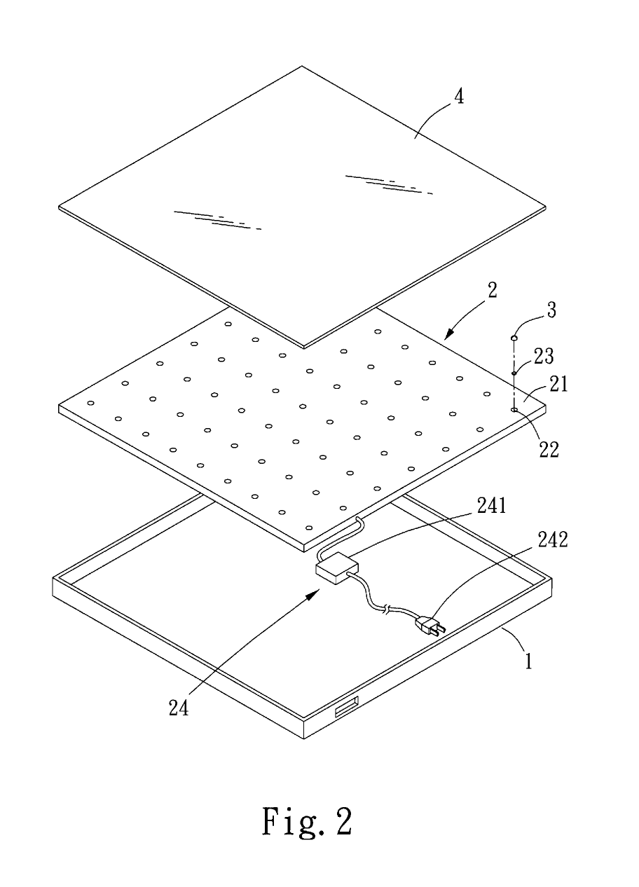

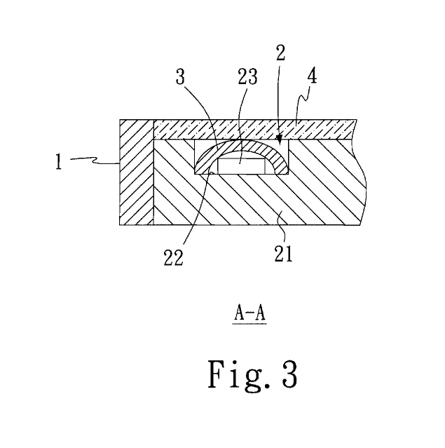

Referring to FIGS. 1, 2 and 3, there are shown a perspective view of a lamp, an exploded view of the lamp, and a cross-sectional view of the lamp taken along line A-A of FIG. 1 according to the present invention. As shown in the drawings, the lamp of the present invention comprises a frame 1, a light emitting mechanism 2, a plurality of lenses 3, and a lampshade 4.

The frame 1 is made of a metal or a non-metal.

The light emitting mechanism 2 is coupled to the frame 1. The light emitting mechanism 2 comprises a carrier 21, a plurality of dents 22 disposed on the carrier 21, light-emitting diodes 23 disposed in the dents 22, respectively, and series-connected to each other, and a power supply unit 24 connecting with the light-emitting diodes 23. The power supply unit 24 comprises a transformer 241 and a plug 242 connected to the transformer 241.

The lenses 3 are coupled to the lampshade 4, or are coupled to the dents 22 and configured to hermetically seal the light-emitting diodes 23, respectively. The lenses 3 are convex lenses or concave lenses.

The lampshade 4 is coupled to the frame 1 and configured to hermetically seal the light emitting mechanism 2. The lampshade 4 is made of a light-penetrable material.

To apply the present invention, a user fixes the frame 1 to the ceiling, uses the light emitting mechanism 2 as an illuminating lamp, and inserts the plug 242 of the power supply unit 24 of the light emitting mechanism 2 into an indoor electrical outlet or connects the plug 242 to an indoor switch (not shown), such that required electric power is retrieved, subjected to AC/DC transformation by the transformer 241, and supplied to the light-emitting diodes 23, so as to drive the light-emitting diodes 23 to generate light; meanwhile, the light emitted from the light-emitting diodes 23 is focused by means of the lenses 3. Due to the directivity of the light-emitting diodes 23 of the light emitting mechanism 2 and the reflective surfaces of the dents 22, the illumination angles of the light-emitting diodes 23 are so large that the light emitted from the light-emitting diodes 23 cannot be efficiently directed to a required position and angle. According to the present invention, it is feasible to use the lenses 3 to correct the illumination positions and angles of the light-emitting diodes 23, such that the light emitted from the light-emitting diodes 23 can be fully utilized. Afterward, the light exits the lenses 3 to attain a large illumination angle. With the carrier 21 being a printed circuit board (PCB), the back side of the carrier 21 enables all copper-clad heat dissipation whereby power-induced heat can be quickly dissipated. Furthermore, due to the separation of the power and the carrier 21, the power-induced heat only exists outside the carrier 21 and thus does not have any effect upon the light-emitting diodes 23; hence, the light-emitting diodes 23 are advantageously characterized by a low operating temperature and thus long service life. Accordingly, a lamp of the present invention comprises the light-emitting diodes 23 and the lenses 3 and thus is capable of saving power.

Hence, the present invention meets the three requirements of patentability, namely novelty, non-obviousness, and industrial applicability. Regarding novelty and non-obviousness, the present invention discloses a lamp which comprises lenses and light-emitting diodes for generating light focused by the lenses, such that the lamp is advantageously characterized by a large illumination angle and capable of saving power. Regarding industrial applicability, products derived from the present invention can meet market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A lamp, comprising:
a frame;
a light emitting mechanism coupled to the frame, the light emitting mechanism comprising a carrier, a plurality of dents disposed on the carrier, light-emitting diodes disposed in the dents, respectively, and series-connected to each other, and a power supply unit connecting with the light-emitting diodes;
a lampshade coupled to the frame and configured to hermetically seal the light emitting mechanism; and
a plurality of lenses coupled to the lampshade, or coupled to the dents and configured to hermetically seal the light-emitting diodes, respectively.

2. The lamp of claim 1, wherein the power supply unit comprises a transformer and a plug connected to the transformer.

3. The lamp of claim 1, wherein the lenses are convex lenses or concave lenses.

4. The lamp of claim 1, wherein the lampshade is made of a light-penetrable material.
